(19) United States
(12) Patent Application Publication
(10) Pub. No.: US 2014/0346402 A1
(43) Pub. Date: Nov. 27, 2014

(54) Apparatus and Method for Natural Gas Reformation

(71) Applicant: Karl-Heinz Tetzlaff, Kelkheim (DE)

(72) Inventor: Karl-Heinz Tetzlaff, Kelkheim (DE)

(21) Appl. No.: 14/366,463

(22) PCT Filed: Dec. 18, 2012
(86) PCT No.: PCT/EP2012/075961

§ 371 Date: Jun. 18, 2014

(30) Foreign Application Priority Data
Dec. 20, 2011 (EP) 11194439.3

(51) Int. Cl. C01B 3/38; B01J 12/00

(52) U.S. Cl. CPC C01B 3/386; B01J 12/007; C01B 2203/0261; C01B 2203/1628
USPC 252/373; 422/187

(57) ABSTRACT

An apparatus for the catalytic reaction of gaseous hydrocarbons into synthesis gas by means of oxygen is disclosed. In order to improve the apparatus it is provided for the catalyst chamber containing the gas and the catalyst particle to be separated from the oxygen chamber containing the oxygen by a gas-permeable wall.

The invention relates to a catalytic method for producing synthesis gas from gaseous hydrocarbons, in particular natural gas, by means of oxygen-containing gases, wherein the chamber containing the catalyst is separated from the chamber containing the oxygen by a gas-permeable wall. Further, the invention relates to an apparatus for carrying out the method.

### PRIOR ART

Reformers for the catalytic reformation of natural gas as well as corresponding methods have been known for a long time. It is necessary in this respect to distinguish in particular between commercial-scale reformers and reformers for the decentralised provision of small amounts of synthesis gas, in particular for operating decentralised fuel cells. The latter do not constitute commercial-scale systems. Rather, these are small, compact systems which are in some cases mobile. Therefore, and because they are operated together with expensive devices such as fuel cells, which place high demands on the purity of the produced synthesis gas, partially rather complex designs are required for such reformers.

In the case of commercial-scale reformers that produce for example more than 100 m³ synthesis gas per hour, due to the size of such systems and the very high throughput, only simple systems are contemplated not least for cost reasons, which can therefore also be produced and operated at low costs. Therefore, the present invention relates in particular to commercial-scale reformers.

Allothermal reformers for reforming gaseous hydrocarbons on a commercial scale typically have a fixed bed of catalyst pellets, through which hydrocarbons and steam flow. The steam and the hydrocarbons react with each other on the catalyst pellets under formation of synthesis gas. The allothermal reformation of gaseous hydrocarbons constitutes an endothermal process, to which heat has to be supplied. The heating of the tubular catalyst chambers takes place from the outside through air powered gas burners, wherein the heat exchange of the flue gases takes place via the walls of the tubes onto the resting catalyst particles in the tubes. The tubes of typically 100 mm diameter are designed for an internal pressure of 25 bars to 50 bars. The poor heat transfer on the outside and the inside results in large reaction chambers. This is a considerable disadvantage. In addition, due to the high temperatures on the burners, large amounts of air pollutants are formed.

An autothermal reaction of gaseous hydrocarbons with pure oxygen usually takes place on catalyst-coated ceramic honeycomb bodies. The reaction takes place here very quickly, which results in temperatures that can hardly be controllable and that cannot be withstood by cheap nickel-based catalysts.

### OBJECT OF THE INVENTION

The invention is therefore based on the object of developing and implementing a method and an apparatus of the respectively mentioned type in such a way that the disadvantages described are avoided.

The object is achieved by means of a burnerless apparatus, which can be operated in an allothermal and an autothermal manner, and a method according to the preambles of claims 1 and 12. Claims 2 to 11 and 3 to 17 relate to further advantageous embodiments of the invention.

### DESCRIPTION

The steam reformation of natural gas into synthesis gas is an endothermal process. In the method according to the invention, the endothermal energy is carried out by a partial oxidation of the fuel gas with oxygen. Fuel gas is to be understood to mean natural gas, synthesis gas or intermediate stages which are formed during the process. The term oxygen also includes oxygen-containing gases such as air.

The apparatus according to the invention consists of a reactor that is divided into an oxygen chamber and a catalyst chamber by gas-permeable walls. The gas-permeable walls are preferably formed as tubes.

The pressure differential can now be adjusted in such a way that the fuel gas flows into the oxygen chamber and is combusted directly on the tubes. In this way, an allothermal process is achieved.

If the pressure differential is adjusted in such a way that the oxygen flows into the catalyst chamber, the fuel gas will be at least partially oxidised directly on the tubes. In this way, an autothermal process with an enhanced CO2 content in the synthesis gas is achieved.

All kinds of gas-permeable tubes can be used which are able to withstand the usual temperatures of 500° C. to 1100° C., i.e. metal tubes with small holes, tubes formed from metal sheet plates having internal supports, sintered tubes made from metal or ceramics and fibre material tubes. Ceramic tubes should, due to the risk of breaking, preferably be made from short cylinder sections which are centred from the inside and pre-tensioned using a metal structure. The openings and pores should be smaller than the catalyst particles. What is of advantage is a structure having a large pore space on the tube wall where oxygen and fuel gas meet, and a less gas-permeable structure on the other side of the tube wall. Such a structure may also be provided by means of concentric tubes. The less gas-permeable structure is primarily used for metering gas through a pressure differential, a coarser structure with a higher proportion of pores is used for achieving better oxidation and better heat transfer onto the tube.

Ceramic tubes have a high compressive strength. Therefore, a higher pressure should preferably be applied to these tubes on the outside, but not on the inside. What is of advantage in this sense is if the tubes have a small diameter.

Oxidation takes place directly on or in the tube wall. Due to the short distance between the oxidation zone and the tube wall, the heat is directly transferred by heat conduction. Therefore, the heat input is by several orders of magnitude higher than the heat transfer of hot flue gases onto a tube wall. This means that the method according to the invention acts as though the tubes were directly electrically heated. Thus, the good heat transfer from a fluidised bed to a tube can be fully utilised, as a result of which a very high power density is achieved in the reactor.

The catalyst chamber may be located both in the tubes and around the tubes. The gas velocity and the size of the catalyst particles can be selected in such a way that the catalyst particles form a fixed bed or a stationary fluidised bed or are partially kept mainly in suspension. In this case it is particularly advantageous if the catalyst particles are separated at the top end of the catalyst chamber by means of a separation device and flow back into the catalyst chamber.

As a result of the use of the separation device, the space between the top side of the fluidised bed and the outlet can be designed to be smaller, because any catalyst particles that overspill are separated by the separation device and are returned.

The separation device may be formed from devices which utilise gravity, utilise centrifugal force or act as filters. Separation devices operating on the basis of gravity are for example lamella separators which are made from metal sheet and have oblique passageways which are inclined towards the vertical. The metal sheets preferably have a corrugated or honeycomb structure, so that the catalyst particles in the grooves can flow back more easily into the catalyst chamber. The lamella separators may also be formed from ceramics, as is customary in the case of exhaust gas or flue gas catalysts. Lamella separators are particularly suitable on account of their low design profile and their gentle separation. Lamella separators also allow a gentle classification. Thus, carbon particles and soot that may form during the process can pass through the lamella separator, whereas the larger and heavier catalyst particles are returned back into the catalyst chamber. Therefore, gravity-based lamella separators are particularly preferred.

Lamellae are also known as cyclone type separators. These have a curved shape and the flow through them is preferably horizontal. As a result of the curved shape, the catalyst particles collect on the walls and are thus separated.

One popular type of centrifugal separators are cyclones. They may be installed both inside and outside of the reactor.

Another very effective type of separator device are filter elements such as for example cartridge filters. By shaking or as a result of short pressure pulses from the pure gas side, the catalyst particles can be returned back into the catalyst chamber.

The apparatus according to the invention is not only suitable for reformers that are operated at a typical temperature of 850° C., but also for pre-reformers which are operated at significantly lower temperatures.

### EXAMPLES

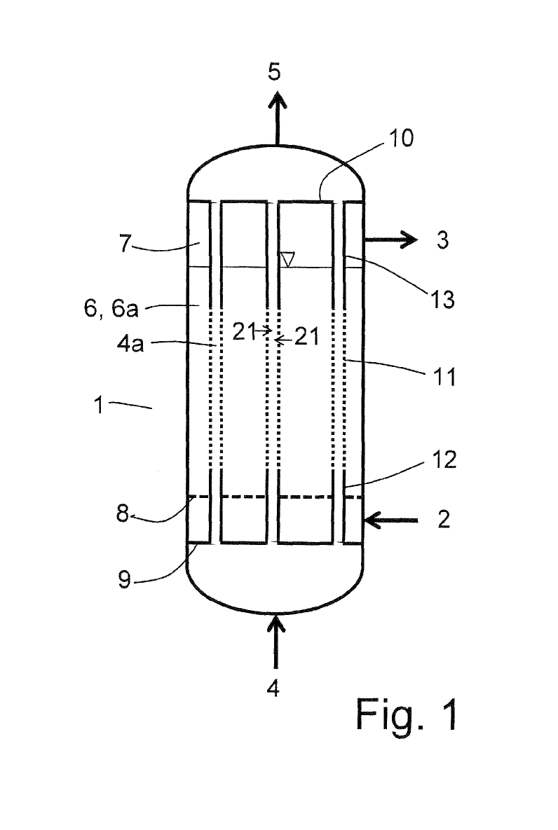

The invention will be described below by way of example with reference to FIGS. 1 to 14.

FIG. 1 shows an allothermal reactor with a stationary fluidised bed.

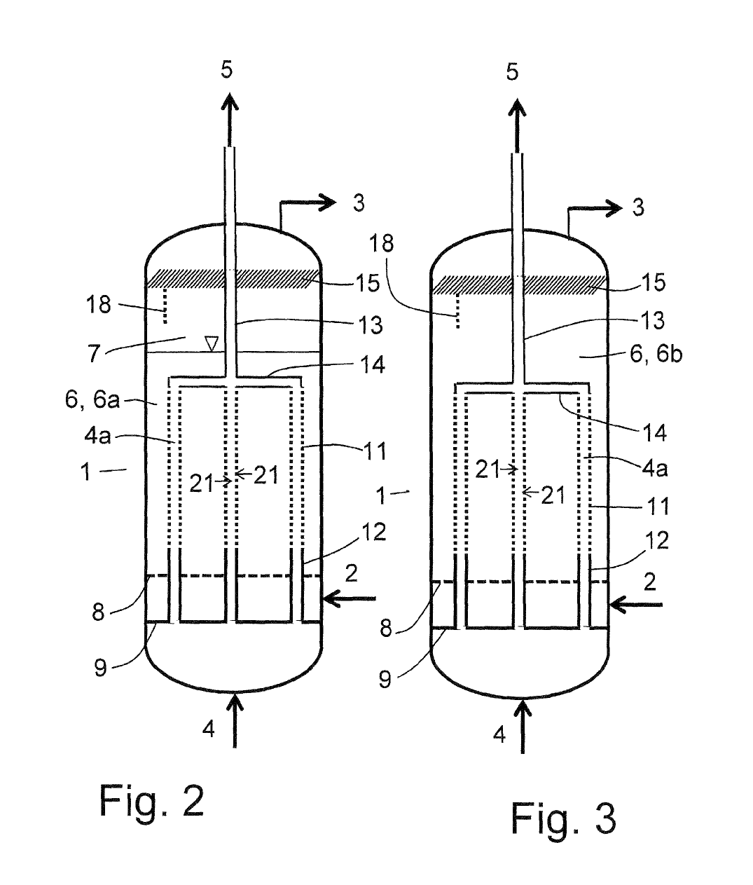

FIG. 2 shows an allothermal reactor with a stationary fluidised bed and a separation device.

FIG. 3 shows an allothermal reactor with a circulating fluidised bed and a separation device.

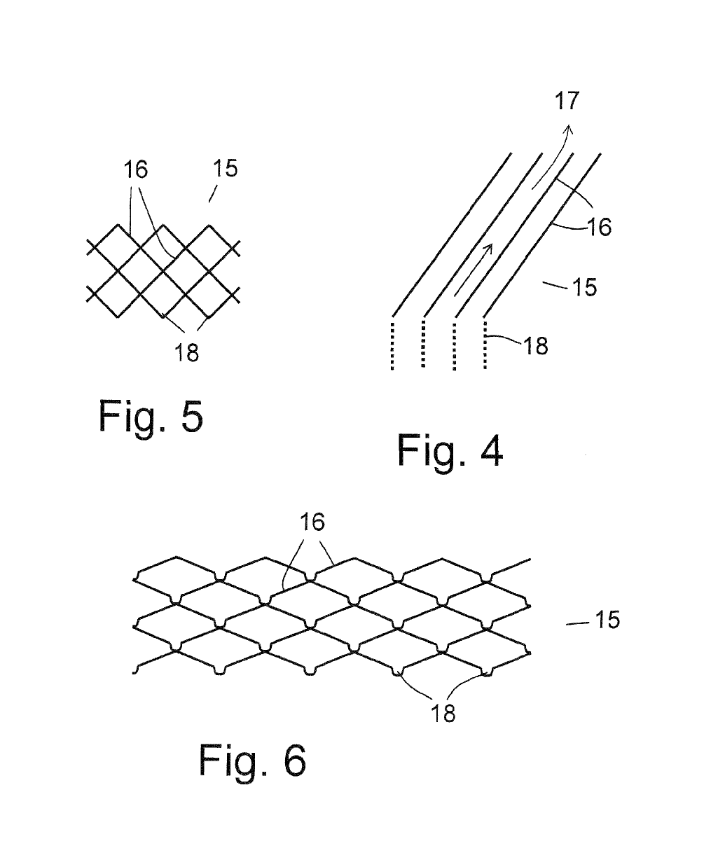

FIG. 4 shows a lateral view of a lamella separator.

FIG. 5 and FIG. 6 show a cross-sectional view of a lamella separator.

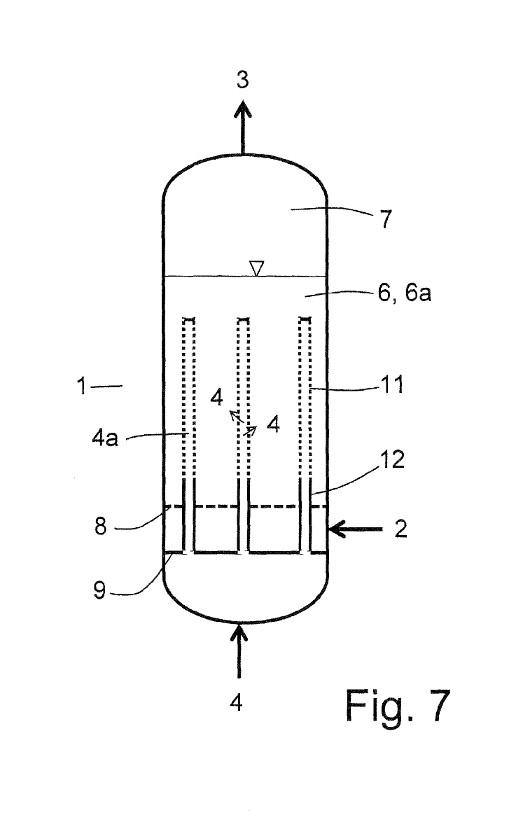

FIG. 7 shows an autothermal reactor with a stationary fluidised bed.

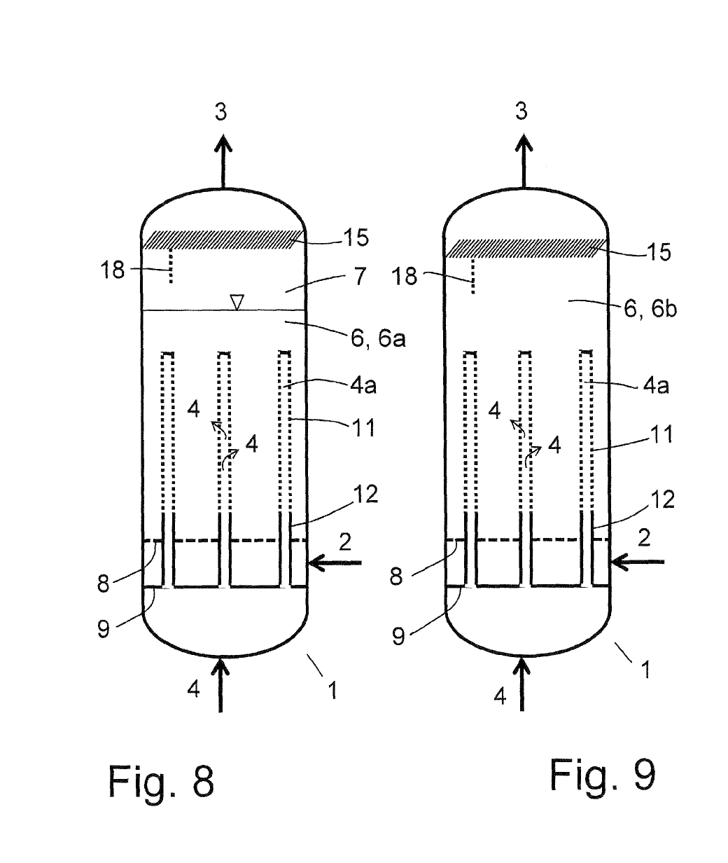

FIG. 8 shows an autothermal reactor with a stationary fluidised bed and a separation device.

FIG. 9 shows an autothermal reactor with a highly fluidised bed and a separation device.

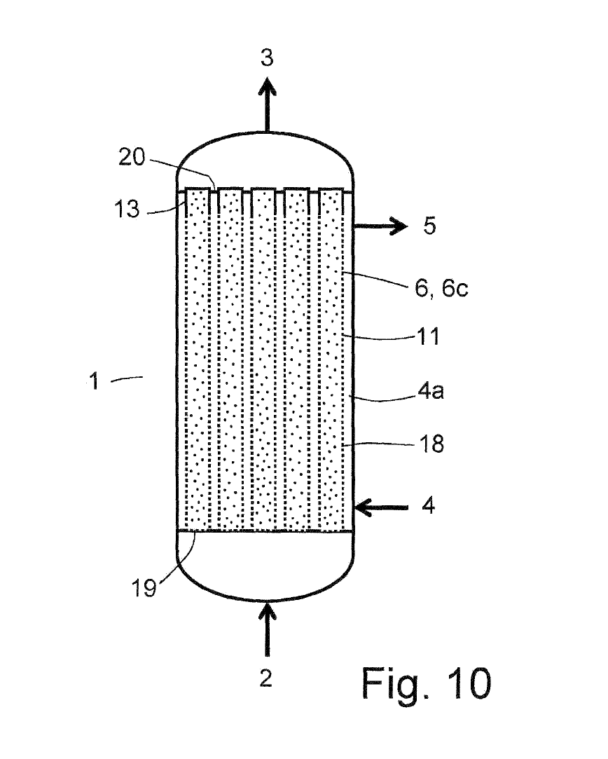

FIG. 10 shows an allothermal reactor with a fixed bed.

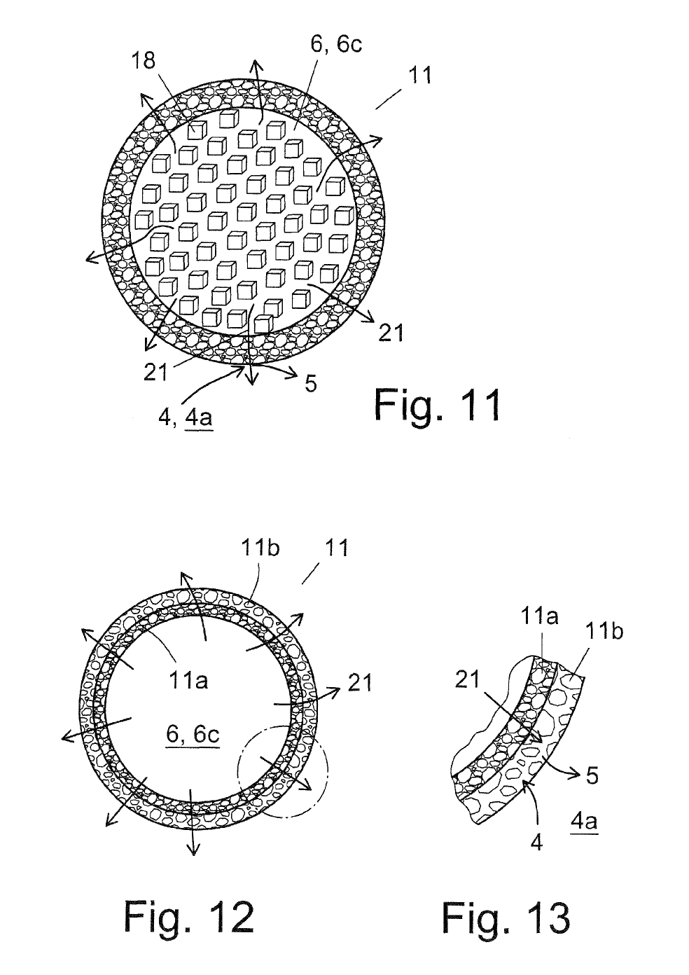

FIG. 11 shows a section of a fixed bed in the tube in an allothermal operating mode.

FIG. 12 shows a multi-layered porous tube with fine pores on the inside and coarse pores on the outside.

FIG. 13 shows a detail of FIG. 12.

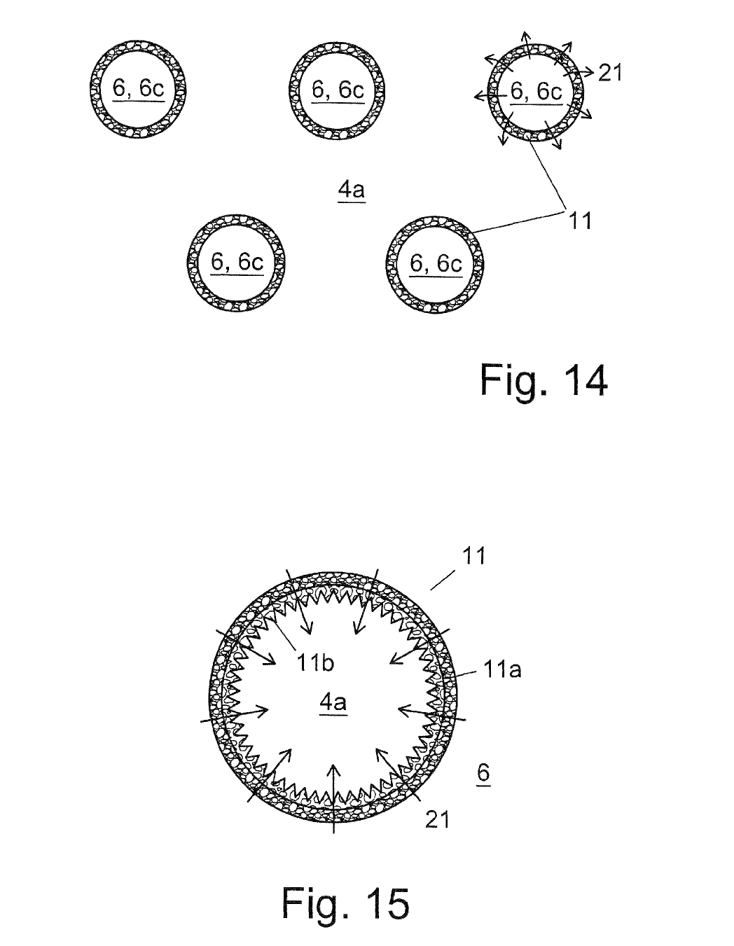

FIG. 14 shows an arrangement of porous tubes with an external oxygen chamber.

FIG. 15 shows a tube cross section wherein the surface area of the tube wall is enlarged by a rib structure in the oxygen chamber.

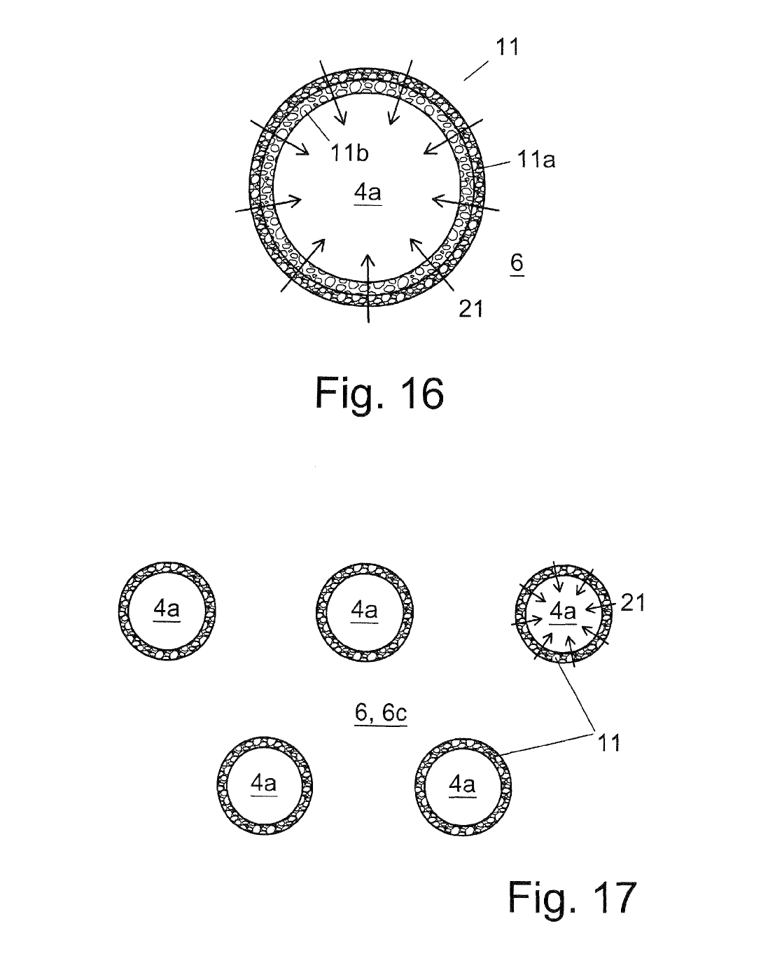

FIG. 16 shows a tube cross section, wherein the surface area of the tube wall to the oxygen chamber is enlarged by an increased porosity.

FIG. 17 shows an arrangement of porous tubes with an internal oxygen chamber.

FIG. 1 shows an allothermal reactor 1, wherein the catalyst chamber 6 is formed as a stationary fluidised bed 6a. The reactor 1 further includes a gas chamber 7 above the fluidised bed. In the catalyst chamber 6, a plurality of porous tubes 11 is provided, which form the oxygen chamber 4a. Oxygen 4 flows through the tube bottom 9 into the porous tubes 11 and exits the reactor 1 through the tube bottom 10 as flue gas 5 which substantially consists of CO2, O2, H2O and, if necessary, N2. The tube feed lines 12 and 13 outside of the fluidised bed 6a are not porous. The connection to the porous tubes 11 may be implemented as a plug-in connection with a labyrinth seal, because absolute density is not critical. The raw gas 2 to be reformed is introduced between the tube bottom 9 and the nozzle bottom 8 and exits the reactor 1 as synthesis gas 3. The pressure difference between the catalyst chamber 6 and the oxygen chamber 4a will now be adjusted in such a way that part of the fuel gas 21 flows into the oxygen chamber 4a, namely just enough so that the energy needed for this endothermal process is provided. In a fluidised bed, the fuel gas 21 largely corresponds to the synthesis gas 3 at the outlet of the reactor 1. Further details with regard to the porous tubes 11 will be described further below with reference to FIGS. 15 to 17. FIG. 2 largely corresponds to FIG. 1. Instead of a tube bottom, however, the porous tubes 1 are here combined using manifolds 14. The flue gas 5 is discharged via the conduit 13. As a new element, a separation device 15 in the form of lamellae is provided above the stationary fluidised bed 6a. Any discharged catalyst particles are returned back into the free chamber 7 by the separation device 15. This is symbolically indicated by falling catalyst particles 18.

FIG. 3 largely corresponds to FIG. 2. The difference consists here in the fact that the catalyst particles 18 are so small and the rate of fluidisation is so high that no detectable upper limit of the fluidised bed is formed. In this process, the catalyst particles 18 are partially kept suspended and any overshooting catalyst particles 18 are separated by the separation device 15 and are returned into the reactor 1. Due to their small impulse, the small catalyst particles 18 experience only very minor mechanical stress. Therefore, the usual ceramic protective shell around the catalyst particles 18 may be dispensed with. Because of this and because of the small dimensions, the diffusion distances to the active centres of the catalysts are very short. This considerably reduces the required amount of catalyst.

FIGS. 4 to 6 show details of a separation device 15. The separation device 15 is here formed as a lamella separator, wherein the catalyst particles 18 are separated by way of gravity.

FIG. 4 shows a vertical section through such a lamella separator. It consists of a plurality of sheets 16 that are positioned at an angle. As indicated by arrows 17, the synthesis gas 3 flows through these narrow passageways. In the process, any entrained catalyst particles 18 will descend down to the bottom and will slide back into the reactor 1. FIG. 5 and FIG. 6 show a view in the direction of the axis of the passageway of a lamella separator. It is particularly advantageous to form the sheets 16 in such a way that the catalyst particles 18 can collect in grooves 18, where the flow velocity of the gas is lower than at the centre and therefore the return transfer of the catalyst particles 18 is facilitated.

FIG. 7 shows an autothermal reactor 1 which is of a design similar to that of the reactor in FIG. 1. The difference is that the pressure difference between the oxygen chamber 4a and the catalyst chamber 6 is selected such that the oxygen 4 flows into the catalyst chamber 6. The catalyst chamber 6 is here formed as a stationary fluidised bed 6a. The oxidation of the fuel gases 21 is carried out directly on the outer wall of the porous tubes 11. In a fluidised bed, the fuel gas 21 largely corresponds to the synthesis gas 3. As a result of the large surface area of the porous tubes 11 and the high turbulences in fluidised bed reactors it is ensured that the catalyst particles 18 will not overheat.

FIGS. 8 and 9 respectively show an autothermal reactor 1 with a stationary fluidised bed 6a and a highly fluidised bed 6b, wherein the catalyst particles are at least partially kept in suspension. As in FIG. 7, here too the oxygen 4 flows from the oxygen chamber 4a into the catalyst chamber 6. As in FIGS. 2 and 3, separation devices 15 are provided in the top part of the reactor 1 in FIGS. 8 and 9.

FIG. 10 shows an allothermal reactor 1, wherein the catalyst chamber 6 is formed as a fixed bed 6c. The catalyst particles 18 are here located in the catalyst chamber 6 in the porous tubes 11. The oxygen chamber 4a is arranged around the tubes. The pressure difference is here adjusted such that the fuel gas 21 flows from the catalyst chamber 6 into the oxygen chamber 4a. The porous tubes 11 are prevented from falling out by a screen at the tube bottom 19. At the top end, the porous tubes are surrounded by a gas-impermeable head tube 13 that is fastened in the head plate 20. The raw gas 2 flows from the bottom into the reactor 1 and exits the reactor 1 as synthesis gas 3. Oxygen 4 is introduced into the oxygen chamber 4a and exits the reactor 1 as flue gas 5. The strength of the energy input along the longitudinal axis may be adjusted by means of a different gas resistance of the porous tubes 11 along the axis thereof. This advantage is absent when solid tubes are heated with flue gases.

FIG. 11 shows the cross section of the porous tube 11 from FIG. 10. Flue gas 21 flows from the catalyst chamber 6 outwards into the oxygen chamber 4a. On the outer wall of the porous tube 11, the flue gas 21 will now be oxidised by the oxygen 4. The flue gas 5 mixes here with the oxygen. As is the case with all combustion processes, it is advantageous to work with a small amount of excess oxygen. For the sake of heat transfer it is advantageous if the porous tube 11 has a higher porosity in the oxidation zone.

This principle is schematically shown in FIGS. 12 and 13. The different porosity is here achieved by fitting a fine-pored tube 11a and a coarse-pored tube 11b into each other. FIG. 13 shows an enlarged section from FIG. 12. The flue gas 21 flowing out meets with the oxygen 4 as early as in the pore chamber 11b and oxidises the fuel gas into flue gas 5. In this way, relationships similar to the ones in a pore burner are established. In this way, the heat is well transferred onto the tube and is transported to the inner wall by heat conduction. In this way, the hot tube 11a heats the catalyst chamber 6.

FIG. 14 shows a cross-sectional view of the arrangement of FIG. 10. Of course, the reactor can also be operated in such a way that the catalyst chamber 6 is arranged around the tubes 11 and the oxygen chamber 4a is disposed in the tubes 11. In this case, the oxidation zone would be on the inner wall of the tubes 11. The porosities of the tubes 11a and 11b would then have to be correspondingly swapped around.

FIGS. 15 to 17 show such a case. In FIG. 16, the oxygen chamber 4a and therefore the oxidation zone are located in the porous tubes 11. The coarser structure 11b is located on the inside and the finer metering structure 11a is located on the outside. The fuel gas 21 flows from the catalyst chamber 6, which is arranged around the tubes, into the inside of the tube and is there oxidised directly on the inner wall or in the inner wall. Instead of a coarser structure 11b in FIG. 16, the coarser structure can also be supported by way of shaping. Such a case is illustrated by the rib structure in FIG. 15. A larger oxidation surface has here been provided by a rib structure on the tube 11b. In order to enhance turbulence, the grooves may also be arranged to be helical. In order to improve heat transfer to the catalyst particles 18, a rib structure may be provided inside and outside on the tube wall 11.

FIG. 17 shows a reactor cross section wherein the catalyst chamber 6 is provided around the porous tubes 11. The catalyst chamber may be designed as a stationary fluidised bed 6a, as a circulating fluidised bed 6b or as a fixed bed 6c.

### ADVANTAGES

Oxidation in the pore chamber of the tube wall allows a heat transfer that is improved by orders of magnitude compared to the heat transfer from flue gases to a tube wall. This allows a small reactor volume with high performance also in the case of an allothermal operating mode. Moreover, the catalyst chamber may be formed as a fluidised bed, which improves heat transfer onto the catalyst particles and ensures an even temperature distribution in the catalyst bed. In the case of an autothermal operating mode with pure oxygen, the operating conditions with regard to temperature, dwell time, catalyst size, catalyst type and arrangement may be adjusted in a specific manner, because the oxygen no longer impacts directly on the catalyst particles. The oxidation in the porous structure of the tubes is similar to that of a pore burner, wherein the temperatures are also significantly lower than in a free flame. Moreover, the temperature difference between the combustion chamber in the pores and the catalyst particles is much smaller. As a result, fewer pollutants will be formed.

### LIST OF REFERENCE SIGNS

1 Reactor
2 Raw gas
3 Synthesis gas
4 Oxygen
4a Oxygen chamber
5 Flue gas
6 Catalyst chamber
6a Stationary fluidised bed
6b Circulating fluidised bed
6c Fixed bed
7 Free chamber
8 Nozzle bottom
9 Tube bottom upper end
10 Tube bottom lower end
11 Gas-permeable wall in the form of a porous tube wall
11a Metering tube, fine-pored wall
11b Pore combustion chamber, coarse-pored wall
12 Bottom tube
13 Head tube
14 Manifolds
15 Separation device
16 Lamellae
17 Gas flow
18 Catalyst particles
19 Bottom plate
20 Head plate
21 Fuel gas

1. An apparatus for the catalytic reaction of gaseous hydrocarbons into synthesis gas by means of oxygen, comprising a catalyst chamber containing the gas, wherein catalyst particles are separated from an oxygen chamber containing the oxygen by a gas-permeable wall.

2. The apparatus as claimed in claim 1, wherein the gas-permeable wall is formed by a plurality of tubes.

3. The apparatus for the catalytic reaction of gaseous hydrocarbons of claim 2, wherein the tubes are formed in multiple layers.

4. The apparatus for the catalytic reaction of gaseous hydrocarbons of claim 2, wherein the tubes have a different flow resistance in their longitudinal axis.

5. The apparatus for the catalytic reaction of gaseous hydrocarbons of claim 2, wherein the tubes have a rib structure.

6. The apparatus for the catalytic reaction of gaseous hydrocarbons of claim 2, wherein the catalyst chamber is arranged around the tubes.

7. The apparatus for the catalytic reaction of gaseous hydrocarbons of claim 2, wherein the catalyst chamber is located within the tubes.

8. The apparatus for the catalytic reaction of gaseous hydrocarbons of claim 1, wherein the catalyst particles are provided as a fixed bed.

9. The apparatus for the catalytic reaction of gaseous hydrocarbons of claim 1, wherein the catalyst particles.

10. The apparatus for the catalytic reaction of gaseous hydrocarbons of claim 1, further comprising at least one separation device at an end of the catalyst chamber.

11. The apparatus for the catalytic reaction of gaseous hydrocarbons of claim 10, wherein the separation device is formed as a lamella separator.

12. A method for the catalytic reaction of gaseous hydrocarbons by means of oxygen into synthesis gas as claimed in claim 1, comprising the steps of selecting a pressure difference between the catalyst chamber and the oxygen chamber such that a gas exchange takes place.

13. The method for the catalytic reaction of gaseous hydrocarbons of claim 12, wherein the pressure difference is selected such that gas from the catalyst chamber flows into the oxygen chamber.

14. The method for the catalytic reaction of gaseous hydrocarbons of claim 12, wherein the pressure difference is selected such that oxygen flows into the catalyst chamber.

15. The method for the catalytic reaction of gaseous hydrocarbons of claim 12, wherein a flow velocity of the gas in the catalyst chamber and a size of the catalyst particles are selected such that a fixed bed is formed.

16. The method for the catalytic reaction of gaseous hydrocarbons of claim 12, wherein a flow rate in the catalyst chamber and a size of the catalyst particles are selected such that a fluidised bed is formed.

17. The method for the catalytic reaction of gaseous hydrocarbons of claim 12, wherein fluidised catalyst particles are returned back into the catalyst chamber by means of a separation device.
